(19) United States
(12) Patent Application Publication
(10) Pub. No.: US 2006/0235781 A1
(43) Pub. Date: Oct. 19, 2006

(54) Systems, methods, and software for analyzing corporate earnings data

(76) Inventors: Ronald Perez, New York, NY (US); Ludo Pauliny, New York, NY (US)

Correspondence Address: Schwegman, Lundberg, Woessner & Kluth, P.A., P.O. Box 2938, Minneapolis, MN, 55402, US

(21) Appl. No.: 11/175,911

(22) Filed: Jul. 5, 2005

Related U.S. Application Data
(60) Provisional application No. 60/585,410, filed on Jul. 2, 2004.

(51) Int. Cl. G06Q 40/00

(52) U.S. Cl. 705/35

(57) ABSTRACT

A financial information system provides enhanced data and/or indicators regarding reported corporate earnings.

### RELATED APPLICATION

This application claims priority to U.S. Provisional patent application 60/585,410, which was filed on Jul. 2, 2004 and which is incorporated herein by reference.

### COPYRIGHT NOTICE

One or more portions of this patent document contain material subject to copyright protection. The copyright owner has no objection to the facsimile reproduction by anyone of the patent document or the patent disclosure, as it appears in the Patent and Trademark Office patent files or records, but otherwise reserves all copyrights whatsoever. The following notice applies to this document: Copyright 2003 and 2004, Thomson Financial.

### TECHNICAL FIELD

Various embodiments of the present invention concern financial information systems, particularly financial data displays and indicators.

### BACKGROUND

The financial markets, such as U.S. stock markets, have long played a key role in the vitality of the U.S. and world economies. Significant factors in the success of the U.S. financial markets have included public confidence in the financial performance measurements reported by companies.

Recent years have seen increased corporate engineering of performance data, such as reported earnings, that in some of the most egregious instances, such as the infamous Enron scandal, have led thousands of investors to lose enormous sums of money. As a consequence, public confidence in financial markets eroded significantly and a need arose for public safeguards.

In response to this need, one of the present inventors pioneered development and introduction of the Earnings Purity™ scoring system as part of Thomson Financial's Baseline™ online research tool. (Earnings Purity and Baseline are both trademarks of Thomson Financial Inc. of New York, N.Y.) This tool, which is used by professional investors and investment advisors, provides an online interface and analytical tools for stock (or equity) information, such as earnings, revenues and cash flow estimates, income statements, and balance sheets for over 12,000 U.S. and Canadian companies.

The Earnings Purity scoring system provided users a value derived by summing the previous twelve quarters of announced operating (or pro form a) earnings for a given company and calculating the percentage of that sum which is not derived from unusual write-offs (or exclusions.) Thus, for example, a company that had no unusual write-offs (special charges that are not regarded as on-going expenses) would be assigned a score of 100%, indicating that its earnings reports over the 12 quarters were consistently devoid of one-time write-offs. On the other hand, a company with all its earnings over the three-year period based on write-offs would be assigned an Earnings Purity score of 0%.

Earnings Purity scores for industry, sector, and market-wide composites have also been made available through the Baseline system. These composites allow investors to assess the earnings reporting of any company against its peer group. The Earnings Purity indication system is now being used by many professional investors as part of their stock selection process.

Although the Earnings Purity system has been successful in signaling the tendency of companies to use write-offs to inflate earnings, the current inventors recognize several limitations. For example, the system does not link the reported operating earnings and other types of earnings that a company might report, for example, the GAAP earnings reported to the Securities and Exchange Commission. Moreover, the system does not allow expose non-write-off techniques for manipulating or inflating operating earnings.

Accordingly, the present inventors have recognized a need for other ways of protecting the public from inflated earnings reports.

### BRIEF DESCRIPTION OF DRAWINGS

FIG. 1 is a block diagram of an exemplary financial information system which corresponds to one or more embodiments of the present invention.

FIG. 2 is a flow chart of an exemplary method of operation which corresponds to one or more embodiments of the present invention.

### DETAILED DESCRIPTION OF EXEMPLARY EMBODIMENT(S)

This description, which references and incorporate the identified figures and incorporates the appended claims, describes and illustrates one or more exemplary embodiments of the invention(s.) These embodiments, offered not to limit but only to exemplify and teach, are shown and described in sufficient detail to enable those skilled in the art to make and use the invention(s). Thus, where appropriate to avoid obscuring the invention(s), the description may omit certain information known to those of skill in the relevant art.

### Exemplary Financial-Information System

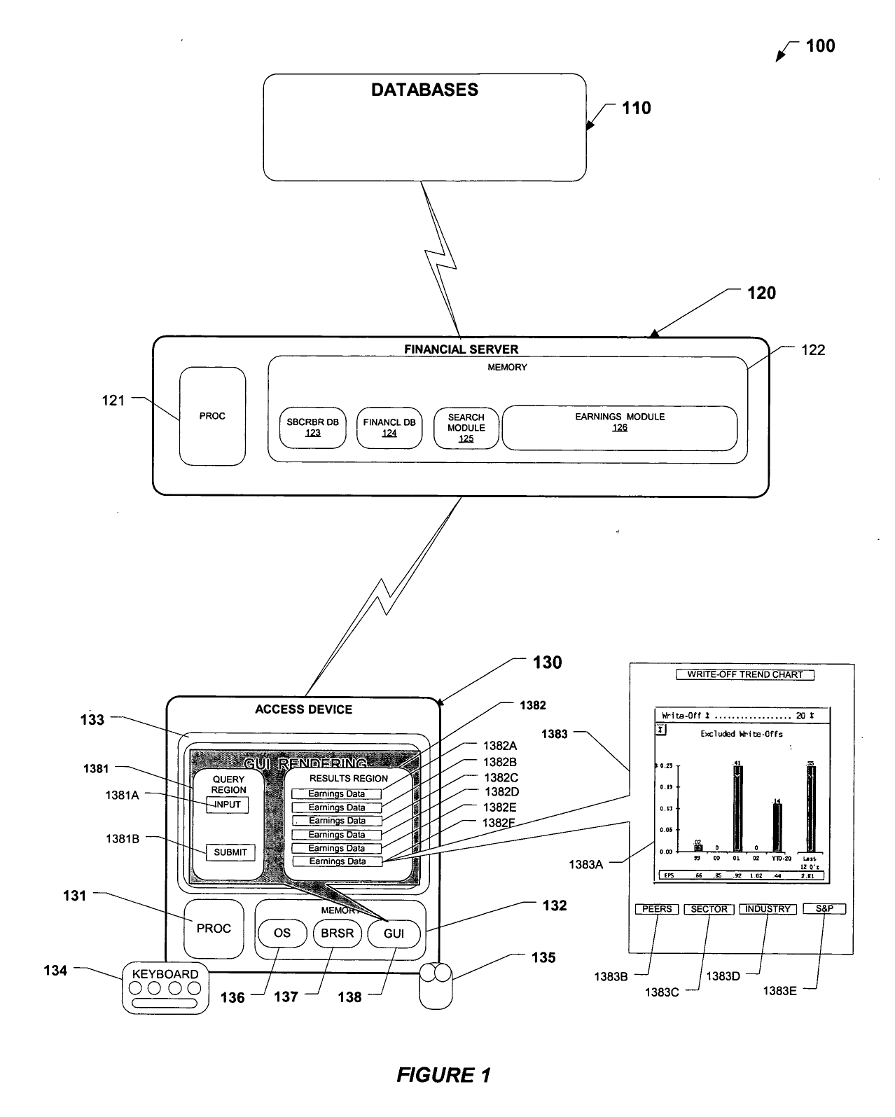

FIG. 1 depicts an exemplary financial-information system 100 that corresponds to one or more embodiments of the present invention. System 100 includes financial databases 110, a financial server 120, and one or more buy-side access devices 130.

### Financial Databases

Specifically, databases 110 includes a set of one or more local or distributed databases of financial information. In the exemplary embodiment, databases 110 include data related to fundamental statistics, price action, ratios, earnings, revenues and cash flow estimates, quarterly and annual income statements, balance sheets, and cash flow statements for over 12,000 U.S. and Canadian stocks. Some embodiments may provide data for stocks of companies in other countries.

The databases, which are updated regularly on a daily or hourly basis, take the exemplary form of one or more electronic, magnetic, or optical data-storage devices, include or are otherwise associated with respective indices (not shown). Each of the indices includes company ticker or other identifying symbols, addresses in association with corresponding document addresses, identifiers, and other information.

Databases 110 are coupled or couplable, for example, via an Internet Protocol (IP) network or other form of permanent, temporary, dedicated, shared wireless or wireline communication link to financial server 120.

### Exemplary Financial Server

Server 120, which is in the exemplary embodiment is representative of one or more servers for serving data in the form of webpages, or other markup language forms with associated applets, ActiveX controls, remote-invocation objects, or other related software and data structures to service clients of various “thicknesses.” More particularly, server 120 includes a processor module 121, a memory module 122, a subscriber database 123, a search module 124, and an earnings module 125.

Processor module 121 includes one or more local or distributed processors, controllers, or virtual machines. In the exemplary embodiment, processor module 121 assumes any convenient or desirable form.

Memory module 122, which takes the exemplary form of one or more electronic, magnetic, or optical data-storage devices, stores a subscriber database 123, search module 124, and earnings module 125.

Subscriber database 123 includes subscriber-related data for controlling, administering, and managing pay-as-you-go or subscription-based or entitlement-based access to one or more databases or other features or functionality accessible via server 120. In the exemplary embodiment, subscriber database 123 includes usernames, access credentials, such as passwords or personal identification numbers, subscription plan information, and so forth.

Search module 124 includes one or more search engines and related user-interface components, for receiving and processing user queries against one or more of databases 110. In the exemplary embodiment, one or more search engines associated with search module 123 facilitate searching of one or more of databases 110 using a structured query language.

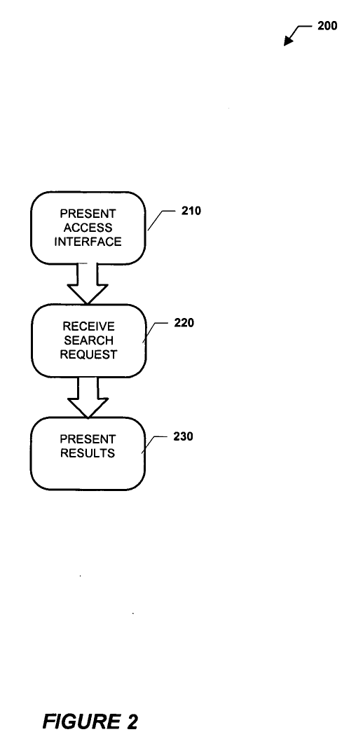

Earnings module 125 includes software, such as user-interface components and algorithms for retrieving, computing, and/or presenting earnings indicators in response to user requests or command. (Further description of the earnings module and its exemplary operation is provided below in connection with access device 130 and with aid of FIG. 2.) Server 120 is communicatively coupled or couplable via a wireless or wireline communications network, such as a local-, wide-, private-, or virtual-private network, to one or more accesses devices represented generally by access device 130.

### Access Device

Access device 130 includes a processor module 131, a memory module 132, a display 133, a keyboard 134, and a graphical pointer or selector (mouse) 135.

Specifically, processor module 131 includes one or more processors, processing circuits, or controllers. In the exemplary embodiment, processor module 131 takes any convenient or desirable form. Coupled to processor module 131 is memory 132.

Memory 132 stores code (machine-readable or executable instructions) for an operating system 136, a browser 137, and a graphical user interface (GUI) 138. In the exemplary embodiment, operating system 136 takes the form of a version of the Microsoft Windows operating system, and browser 137 takes the form of a version of Microsoft Internet Explorer; however, some embodiments use other commercial or non-commercial operating systems and/or browsers. Operating system 136 and browser 137 not only receive inputs from keyboard 134 and selector 135, but also support rendering of GUI 138 on display 133. Upon rendering, GUI 138 presents data in association with one or more interactive control features (or user-interface elements). (The exemplary embodiment defines one or more portions of interface 138 using applets or other programmatic objects or structures from server 120.)

More specifically, graphical user interface 138 defines or provides one or more display regions, such as a query region 1381 and a search-results region 1382. Query region 1381 is defined in memory and upon rendering includes one or more interactive control features (elements or widgets), such as input region 1381A and a query submission button 1381B. Input region 1381A accepts user input, such as company name or stock ticker symbol, defining a query for relevant company and/or industry financial (or non-financial) information from databases 110. And submission button 1381B, upon activation, causes communication of the query to server 120 for processing.

Search-results region 1382 is also defined in memory and upon rendering displays earnings data 1382A-1382F from databases 110 in conjunction with respective interactive control or selection features (not shown separately) for use in selecting one or more associated portions of the earning data. Although FIG. 1 shows query region 1381 and results region 1382 as being simultaneously or concurrently displayed, some embodiments present them at separate times. Additionally, some embodiments display one or more portions of the earnings data on separate screens or windows and/or at separate times, rather than simultaneously as shown in FIG. 1.

More specifically, earnings data 1382A lists, indicates, or is selectable to invoke display of the reported operating earnings (or pro form a earnings) per share of a company identified in a user submitted query.

Earnings data 1382B lists, indicates, or is selectable to invoke display of an the Earnings Purity indication or score for operating earnings over a period of time, such as the last twelve quarters.

Earnings data 1382C lists the number of quarters in a given period, such as the preceding twelve quarters, during which the reported operating earnings were affected by write-offs. In the exemplary embodiment, the write offs (or exclusions) include only unusual write offs. An exemplary set of write-offs includes:
Acquisition Charge
Amortization of Intangibles
Asset Sale Loss
Closing costs
Foreign Exchange Loss
Goodwill Amortization
Impairment Charge
Insurance Settlement
Investment Loss
Litigation Charge
Merger Charge
Non-cash Charge
Nonrecurring Charge
Restructuring Charge
Restructuring Charge—
Workforce
Research and Development
Charge
September 11 th Related
Charge
Severance Charge
Startup Costs
Stock Compensation
Tax Adjustment Loss
Write-off
Write-down

Earnings data 1382C lists, indicates, or is selectable to invoke display of an indication of a number of quarters during which the given company reported write-offs. In the exemplary embodiment, data 1382D ranges between 0 and 12 inclusive; however, other embodiments may use other ranges. Earnings data 1382B lists the reported GAAP earnings per share—that is the earnings per share reported to the Securities and Exchange Commission (or other mandatory or voluntary regulatory body.)

Earnings data 1382D lists, indicates, or is selectable to invoke display of an indication of differential earnings data. In the exemplary embodiment, this data is the difference between the reported operating earnings and the reported GAAP earnings, and thus indicates the amount by which a company's operating earnings overstate or understate what has been reported in its SEC filings over the last twelve quarters. (Operating Earnings minus GAAP EPS.) In some embodiments, the difference is computed based on cumulative earnings per share over the twelve-quarter period; however other embodiments may use a uniform or weighted average over the period, giving for example greater weight to more recent reported earnings.

Earnings data 1382E lists a total percentage write-off for a period, such as twelve quarters. The total percentage is computed as the difference between the Earnings Purity score and 100%. Some embodiments allow users to define the period used for the computation.

Earnings data 1382F lists or is selectable to invoke display of data regarding earnings reporting trends for the given company. The exemplary embodiment provides this data in the form of a trend chart or graph of an Earnings Purity score for each quarter of a period, such as twelve quarters. However, other embodiments provide other measures of the impact of write-offs on reported earnings for longer or shorter periods of time. Some embodiments provide for access to the underlying write-off or exclusion data when a user (with appropriate subscription plan and access credentials) clicks on a segment of the chart.

FIG. 1 shows an exemplary trend graph interface 1383, which can be invoked in some embodiments of the invention by selection of earnings data (interactive feature) 1382F. In addition to graph or data display region 1383A, interface 1383 includes respective peer, sector, industry, and market-wide selection features which upon selection invoke display of the trend data for a given company in context with or juxtaposed with respective peer, sector, industry, and market-wide trend data. More generally, some embodiments display earnings data 1382A-F with an interface having the functionality of interface 1383. (For sake of brevity, separate interfaces are not shown for each.) Moreover, some embodiments allow users to define their own peer group for the comparison of the data, with this option available for each type of earnings data. Some of these embodiments may designate the selectable feature as as “my peer list” to distinguish from a conventional peer list. The peer list may be a stock portfolio for a given client of a professional financial advisor.

### Enhancement of the Earnings Purity Score

To enhance or supplement the value of the Earnings Purity score and other write-off related indicators described above, some embodiments effectively treat expenses associated with off-balance-sheet financing as hypothetical write-offs. Examples of off-balance sheet financing include operating leases, pension funds, R&D agreements, joint ventures, letters of credit, and securitization of receivables.

More particularly, the Earnings Purity computation note above can be modified by treating operating leases as a hypothetical write-off and computing an adjusted Earnings Purity score to use in place of or in conjunction with the original Earnings Purity score. Many companies adjust their lease terms to fit the definition of operating lease—a type of “off-balance sheet financing.” When evaluating company debt exposure and repayment obligations, it is important to remember operating lease agreements because economically they function as long-term liabilities. Some embodiments may also add operating leases to the company debt and provides a separate indicator based on the difference between the ratios for long-term debt (LT Debt) to Total Capital and LT Dept to Total Capital excluding operating leases (and/or other off-balance sheet financing.)

Similarly, the Earnings Purity computation can be modified by treating stock options as hypothetical write-off individually or collectively with the other off-balance sheet financing, such as with the operating leases. To this end, the exemplary embodiment computes a projected and/or actual stock option expense for a given period. Some embodiments may simply compute the ratio of cumulative or average stock-option expense to the reported expenses and provide this ratio or another value or indicator based on this ratio as a separate indicator of the transparency of a companies financial reporting practices.

Pension funding issues, particularly those related to defined benefit plans, can also be used to provide an alternative or separate Earnings Purity score. on earnings or debt or other aspects of reported company financials. A pension plan is a long-term liability that is often not captured on the balance sheets of companies. In defined benefit plans, a company promises to pay employees a future pre-defined benefit at retirement and bears investment risk as it seeks to fund these plans. Many companies that provide these plans assume long-term returns on pension fund investments that are optimistic and thus may be unable to properly fund the plan. Therefore, cash flow and earnings in companies with such plans, especially major industrial manufacturers with large labor forces, are vulnerable to pension funding issues.

To expose the impact or likely impact of the optimistic pension funding assumptions on operating earnings, some embodiments compute current pensions payment obligations based on a more conservative investment growth hypothesis. The investment growth hypothesis may be based for example on average peer, sector, industry, or market-wide (such as S&P) growth assumptions or on long-term treasury bills. The conservative growth hypothesis can then be used to compute an additional projected payment obligation into the pension fund, with the additional payment obligation regarded as a form of hypothetical write-off. This hypothetical pension write-off can then be used in the Earnings Purity computation. Again, some embodiments may simply compute the ratio of cumulative or average hypothetical pension-fund expense to the reported (footnoted) expenses and provide this ratio or another value or indicator based on this ratio as a separate indicator of the transparency of a companies financial reporting practices.

Some embodiments also provide the following per-share listings or related indicators on one or more portions of results region 1382: Price per share; earnings per share, cash flow per share, free cash flow per share, book value per share, enterprise value per share, and EBITDA per share. Regarding margins and profitability, some embodiments also provide Gross Margin, Operating Margin, EBITDA Margin, EBITDA margin relative to that associated with any user selectable ticker symbol, Earnings Before Taxes, Net Profit Margins, Net Profit Margins relative to that associated with any user selectable ticker symbol, Return on Equity, Return on Equity relative to that associated with any user selectable ticker symbol, Earnings Retention, Pretax ROA, ROC, and Reinvestment Rate.

### Exemplary Method of Operation

FIG. 2 shows a flow chart 200 of one or more exemplary methods of operating system 100. Flow chart 200 includes blocks 210-270, which are arranged and described in a serial sequence in the exemplary embodiment. However, other embodiments execute two or more blocks in parallel using multiple processors or processor-like devices or a single processor organized as two or more virtual machines or sub processors. Other embodiments also alter the process sequence or provide different functional partitions to achieve analogous results. Moreover, still other embodiments implement the blocks as two or more interconnected hardware modules with related control and data signals communicated between and through the modules. Thus, the exemplary process flow applies to software, hardware, and firmware implementations.

Block 210 entails presenting a user interface via to one or more users. In the exemplary embodiment, this entails each user directing a browser or other access software on a respective access device, such as access device 130, to a web server, such as server 120, and subsequently logging into the system using appropriate username, password, and/or other authentication techniques. In response to a successful login, the system, more precisely server 120, outputs an interface, such as interface 138 in FIG. 1 (or one or more portions thereof), from server 120 to access device 130 for display. Execution then advances to block 220.

Block 220 entails receiving a query for financial information. In the exemplary embodiment, this entails a user inputting or selecting a company name or ticker symbol via interface via query region 1381 (in FIG. 1).

Block 230 entails presenting search results based on the received query via results region 1382. In the exemplary embodiment, presentation of the results proceed as described above for region 1382. In some embodiments, the earnings data in the search results is computed in realtime via server 120, specifically earnings module whereas in other embodiments all or a portion of the earnings related data is precomputed and stored in database 110.

### CONCLUSION

The embodiments described above are intended only to illustrate and teach one or more ways of making and using the present invention, not to restrict its breadth or scope. The actual scope of the invention, which embraces all ways of practicing or implementing the teachings of the invention, is defined only by one or more of the issued patent claims and their equivalents.

1. A system comprising:
a server coupled to one or more databases;
one or more client access devices, each coupled to the server via an intranet and/or Internet and having or operatively associated with a display for presenting a graphical user interface including one or more user-interface windows or regions and associated control elements at least partially configured or defined by the server, wherein one or more of the window displays corporate earnings-related information for on one or more user selected or defined corporate entities, with the displayed information including an earnings differential indicator which indicates an amount or degree by which a corporate entities reported operating earnings overstate or understate what it has reported in its SEC filings over a period of time, such as 12 months.

2. The system of claim 1, wherein the earnings differential indicator is based on a difference of operating earnings and GAAP EPS.

3. The system of claim 1, wherein the earnings differential indicator is presented in association with a score indicating the degree that a corporate entity's reported earnings reflect actual operating earnings.

4. The system of claim 1, wherein the graphical user interface is a Windows-type interface controlled by a browser application on the client access device.

5. The system of claim 1, including one or more machine-readable medium storing one or more of components of the server, client access device, or graphical user interface.
